(19) United States
(12) Patent Application Publication
(10) Pub. No.: US 2011/0210673 A1
(43) Pub. Date: Sep. 1, 2011

(54) Sensor Element Having a Light Sensor, Communication Transmitter Having a Sensor Element, and Lighting System Having a Sensor Element

(76) Inventor: Axel Pilz, Neuenstein (DE)

(21) Appl. No.: 13/126,976

(22) PCT Filed: Oct. 29, 2008
(86) PCT No.: PCT/EP08/64660

§ 371 Date: Apr. 29, 2011

(51) Int. Cl. H05B 37/02; G01J 1/32

(52) U.S. Cl. 315/158; 250/205

(57) ABSTRACT

A sensor element (101) comprising a light sensor (102), wherein the light sensor (102) is configured for receiving a control signal and wherein the light sensor (102) is a brightness sensor for a lighting system.

The invention relates to a sensor element having a light sensor, a transmitter for communicating with the sensor element, and a lighting system having the sensor element.

Light sensors are used for daylight-dependent adjustment of a lighting system. These light sensors measure the brightness and forward this in the form of a digital or analog signal to a control device and/or to an electronic ballast resistor.

The sensors are mounted in a light and/or separately on the ceiling, for example, and capture the brightness e.g. indirectly as a result of reflection of the light off furniture surfaces or off the floor. In this context, it is intended to maintain the overall brightness, comprising a combination of daylight and artificial light, as far as possible constant at a reference value that can be predefined.

Since the brightness that is measured by a sensor, even given comparable daylight conditions, largely depends on the reflective properties of the surfaces and/or on the mounting height of the sensor, a reference value can only be predefined locally at the individual installation location. For this purpose, the artificial light is adjusted to a desired brightness (e.g. such that a desired working brightness is set on a desktop). The sensor measured value for this location is stored as a reference value in the control device or in the electronic ballast resistor.

Such a setting is preferably only necessary once, when the lighting apparatus is initially installed. During subsequent operation, a change is only necessary in exceptional cases, e.g. if the space or its configuration changes significantly, or if the position of the sensor changes. In many cases, the customer should not have any means of changing said reference value, as this might otherwise result in possibly inadvertent failure to meet the minimum brightness required at workstations.

The setting means are typically integrated in the sensor element. A sensor that is mounted on the ceiling is difficult to reach, however, or considerable expense (time, cost, safeguards) is required to reach every sensor e.g. in an office space with high ceilings by means of a ladder.

Furthermore, it is disadvantageous that such setting means must have corresponding electrical insulation in order to allow safe operation.

The object of the invention is to avoid the disadvantages cited above and, in particular, to indicate an effective approach for providing reference value specifications for sensor elements of a lighting system.

This object is achieved by the features in the independent patent claims. Developments of the invention are derived from the dependent claims.

In order to solve the problem, provision is made for a sensor element comprising a light sensor,
wherein the light sensor is configured for receiving a control signal, and
wherein the light sensor is a brightness sensor for a lighting system.

The lighting system can be an individual light and/or lamp or a multiplicity of lights/lamps which are connected together in a network by means of a bus system and/or a control system, for example.

The approach described here allows a use of the light sensor such that it is also designed for the purpose of receiving the control signal, and therefore a further sensor (e.g. a separate IR sensor) for setting the sensor element is not required.

In a development, the light sensor comprises at least one of the following components:
a phototransistor,
a photodiode,
a photoresistor.

In a further development, the sensor element is integrated in a lamp or light or in a control device, in particular an electronic ballast resistor.

The sensor element can also be (merely) logically, functionally and/or physically connected to the control device and/or the electronic ballast resistor.

In particular, in a development, the control signal is an analog or digital control signal.

In a further development, the control signal is a modulated light signal.

According to the invention, various modulation methods can be used, e.g. amplitude and/or phase modulation.

In a further development, the control signal comprises a signal for setting a reference value and/or the reference value.

In the context of an additional development, the control signal comprises one command for increasing brightness, one command for decreasing brightness, and one command for storing a reference value.

A further development consists in the sensor element receiving the control signal and forwarding it to a control device.

In particular, the sensor element can forward the control signal to the control device without modification and/or analysis in the sensor element.

The control device can be a central control device or a further device on a bus system. Accordingly, the control signal can be forwarded via the bus system by means of a suitable protocol.

In an embodiment, the sensor element receives the control signal, processes it, and forwards the processed control signal and/or a signal resulting therefrom to a control device.

In an alternative embodiment, the sensor element is coupled to a bus system.

In a further embodiment, the bus system is a bus system that is based on a DALI standard.

In particular, the bus system can utilize or provide (implement) the functions of the DALI standard accordingly.

The object cited above is also achieved by means of a transmitter for communicating with the sensor element as described herein,
comprising a light source;
comprising a programming interface for setting and/or generating the control signal,
wherein the control signal can be emitted by means of the light source.

The programming interface can be embodied as a simple operating element, whose activation causes a corresponding signal to be emitted by means of the light source.

In a development, the programming interface comprises at least an operating element and an analysis unit for analyzing the operating element and/or for controlling the light source.

The operating element can comprise at least one button and/or at least one switch, for example.

To this extent, depending on an input via the operating element, a modulated light signal can be generated and emitted via the light source by means of the programming interface which comprises the analysis unit.

The transmitter preferably has a facility for focussing the light that is emitted by the light source, such that direction at the sensor element and setting of said sensor element is simplified accordingly.

In a further embodiment, the light source comprises at least one LED and is used in particular for emitting the control signal and also for general illumination.

The problem cited above is also solved by a lighting system comprising at least one sensor element as described herein.

Exemplary embodiments of the invention are illustrated and explained below with reference to the drawings, in which:

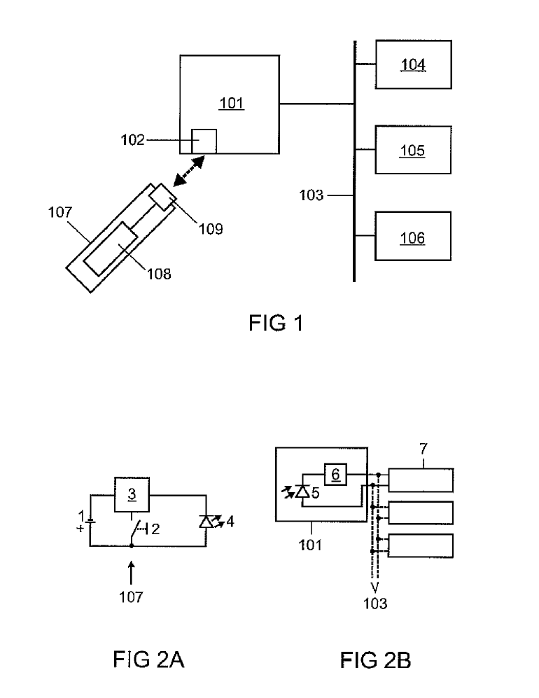

FIG. 1 shows an arrangement for programming a sensor element via a light sensor, wherein the sensor element can be connected to a bus system or to a light/lamp or to an electronic ballast resistor as a discrete device or can be integrated therein;

FIG. 2A shows a block schematic diagram of the transmitter comprising a current source (e.g. a battery), a button, an analysis unit and a light-emitting diode;

FIG. 2B shows a simplified block schematic diagram of the sensor element from FIG. 1 comprising a photodiode as a light sensor, said photodiode being connected to an optional analysis unit;

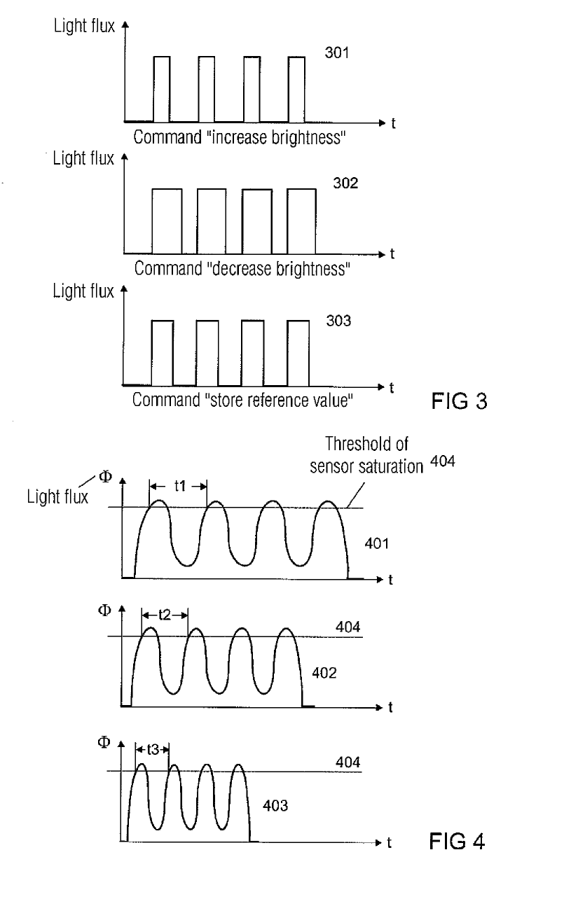

FIG. 3 shows various digital signal profiles in the form of a light flux as a function of the time for the commands or signals “increase brightness”, “decrease brightness” and “store reference value”;

FIG. 4 shows various analog signal profiles in the form of a light flux as a function of the time for the commands “increase brightness”, “decrease brightness” and “store reference value”, wherein a threshold value of the sensor saturation is used for the analog signals at the receiver in order to determine a time duration for a period.

The approach proposed here utilizes an existing light sensor additionally as a receiver for digital and/or analog signals. A light source comprising at least one light-emitting diode (LED) is preferably used as a transmitter.

Therefore a sensor element can be configured via the light sensor, e.g. a phototransistor, a photodiode or a photoresistor, by means of the light source.

The light source preferably transmits to the light sensor using a predefined coding, such that both brightness control instructions for setting a reference brightness and other instructions, e.g. a subsequent store command, can be transferred.

The signals comprising the brightness control instructions and/or the other instructions can be transferred or forwarded from the sensor element to a control device or to an electronic ballast resistor of the lighting system. Alternatively or additionally, the sensor element itself can feature a preprocessing unit or analysis unit, by means of which the signals from the light source are processed and possibly converted into standardized or predefined data units or data telegrams and transferred to the control device or to the electronic ballast resistor of the lighting system.

The signals that are transferred from the light source to the sensor element can be digitally coded or analog signals. The sensor element can therefore be subjected by the light source to defined brightnesses or a sequence of defined brightnesses which are converted and/or recognized as corresponding commands by the sensor element. For example, a series of light pulses of different brightness can be transferred to the sensor element.

The light source can transfer both visible and invisible light to the sensor element. The light can be modulated in different ways, at least one predefined signal and/or command being transmitted to the sensor element by means of the modulation.

The light source is preferably programmable, such that specific reference values can be variably input and a correspondingly coded signal which can be transmitted to the sensor element is generated from the input.

The sensor element can preferably acknowledge receipt of a signal or a valid command. This can be done, for example, by briefly changing a state of the sensor element, e.g. the brightness of a display (e.g. a light-emitting diode).

By using visible light in particular, the light sensor which already exists for the purpose of the light adjustment can also be used as a receiver or as part of a receiver of the aforementioned signal emitted by the light source.

Consequently, it is possible to dispense with any additional installation of e.g. an IR receiver or a radio receiver in the sensor element. It is also unnecessary to arrange further setting means on the sensor element. The setting of the reference value for the sensor element can be done using the light source alone.

As a result of using visible light, the user can direct a focused light beam, in the form of a circle or a dot, in the direction of the sensor element or at the light sensor of the sensor element. Any side-to-side interference with adjacent receivers is largely prevented thus.

As a result of using the generally VW-corrected receiver element which is sensitive to visible light, it is also possible to use light sources without an IR portion as transmitters, i.e. LEDs in particular.

As a result of using visible light, the transmitter can be embodied e.g. as a high-intensity LED flashlight with a corresponding additional modulator.

The transmitter preferably comprises a programming facility for inputting the command or reference value to be transferred to the sensor element.

By way of example, FIG. 1 shows an arrangement for programming a sensor element 101 via a light sensor 102. The sensor element 101 can be connected to a bus system 103 as a discrete device in this case. However, it can also be connected to a light/lamp or electronic ballast resistor, or integrated therein.

By way of example, FIG. 1 shows further components 104 to 106 which are connected to the bus system 103. Each component can be or at least comprise a sensor element, an electronic ballast resistor, a light or lamp, a control device.

The bus system is e.g. a DALI bus system or a bus system based on the DALI standard. In particular, the bus system can be based on an extension of a DALI standard or make use of functions in accordance with the DALI description.

Furthermore, FIG. 1 shows a transmitter 107 (e.g. a light source) for communicating with the sensor element 101 via the light sensor 102. The transmitter 107 comprises a programming interface 108 featuring e.g. an input unit for selecting, predefining and/or setting a reference value. Accordingly, provision can be made for a modulation or coding unit which generates a signal that can be emitted by at least one light-emitting diode 109.

For example, the programming interface 108 is configured in such a way that three functions “increase brightness”, “decrease brightness” and “store reference value” are selectable and the transmitter generates corresponding signals or commands and emits these via the at least one light-emitting diode.

FIG. 2A shows a block schematic diagram of the transmitter 107 comprising a current source 1 (e.g. a battery), a button 2, an analysis unit 3 and a light-emitting diode 4.

The analysis unit 3 can be embodied e.g. as a microprocessor or comprise such. The button 2 can be used for programming or setting a signal that is to be emitted. For example, a long depression of the button 2 can trigger a command “change brightness”, a short depression of the button 2 can trigger a command “switch” (between increasing and decreasing brightness) and a double depression (like a double click) of the button 2 can trigger a command “store reference value”. The analysis unit 3 generates a signal accordingly for emission via the light-emitting diode 4.

FIG. 2B shows a simplified block schematic diagram of the sensor element 101 from FIG. 1, having a photodiode 5 which takes the form of a light sensor and is connected to an optional analysis unit 6. The sensor element 101 is connected to the bus system 103 in accordance with the illustration as per FIG. 1. Also connected to the bus system 103 is e.g. an operating device or control device (e.g. electronic ballast resistor) 7.

FIG. 3 shows various digital signal profiles 301 to 303 in the form of a light flux as a function of the time for the commands “increase brightness”, “decrease brightness” and “store reference value”.

Each command is preferably a periodic signal which is emitted for a specific time duration (e.g. for the duration of a key depression or for a predefined fixed time duration following a key depression). The period duration can be identical for the various commands, wherein a ratio of the on/off times (ratio of the time for the light flux on to the time for the light flux off) can preferably be different for each command per period.

FIG. 4 shows various analog signal profiles 401 to 403 in the form of a light flux as a function of the time for the commands “increase brightness”, “decrease brightness” and “store reference value”. For example, a threshold value of the sensor saturation 404 is used for the analog signals at the receiver in order to determine a time duration t1 to t3 for a period. The length of the period, i.e. the respective time duration t1 to t3, identifies the associated command.

### LIST OF REFERENCE SIGNS

1 Current source
2 Button
3 Analysis unit of the transmitter
4 Light-emitting diode
5 Photodiode
6 Analysis unit of the receiver (or of the sensor element)
7 Operating device or control device (e.g. electronic ballast resistor)
101 Sensor element
102 Light sensor
103 Bus system
104 Component (on the bus system 103)
105 Component (on the bus system 103)
106 Component (on the bus system 103)
107 Transmitter (light source)
108 Programming interface (comprising e.g. operating unit, button, or other)
109 Light-emitting diode (at least one)
301 Signal profile
302 Signal profile
303 Signal profile
401 Signal profile
402 Signal profile
403 Signal profile
404 Threshold value for sensor saturation

1. A sensor element comprising a light sensor, wherein the light sensor is configured for receiving a control signal, and wherein the light sensor is a brightness sensor for a lighting system.

2. The sensor element as claimed in claim 1, wherein the light sensor comprises at least one of the following components:
a phototransistor,
a photodiode,
a photoresistor.

3. The sensor element as claimed in claim 1, wherein the sensor element is integrated in a lamp or light or in a control device.

4. The sensor element as claimed in claim 1, wherein the control signal is an analog control signal or a digital control signal.

5. The sensor element as claimed in claim 1, wherein the control signal comprises a modulated light signal.

6. The sensor element as claimed in claim 1, wherein the control signal comprises a signal for setting a reference value and/or the reference value.

7. The sensor element as claimed in claim 1, wherein the control signal comprises a command to increase brightness, a command to decrease brightness and a command to store a reference value.

8. The sensor element as claimed in claim 1, wherein the sensor element receives the control signal and forwards it to a control device.

9. The sensor element as claimed in claim 1, wherein the sensor element receives the control signal, processes it, and forwards the processed control signal and/or a signal resulting therefrom to a control device.

10. The sensor element as claimed in claim 1, wherein the sensor element is coupled to a bus system.

11. The sensor element as claimed in claim 1, wherein the bus system is a bus system which is based on a DALI standard.

12. A transmitter for communicating with the sensor element as claimed in claim 1,
comprising a light source;
comprising a programming interface for setting and/or for generating the control signal;
wherein the control signal can be emitted by means of the light source.

13. The transmitter as claimed in claim 12, wherein the programming interface comprises at least one operating element and an analysis unit for analyzing the operating element and/or for controlling the light source.

14. The transmitter as claimed in claim 12, wherein the light source comprises at least one LED and in particular is used both for emission of the control signal and for general illumination.

15. A lighting system comprising at least one sensor element as claimed in claim 1.
